(19) United States
(12) Patent Application Publication
(10) Pub. No.: US 2026/0249470 A1
(43) Pub. Date: Aug. 27, 2026

(54) ROBOTIC DEVICE AND METHOD FOR CONTROLLIONG ROBOTIC DEVICE

(71) Applicant: SONY GROUP CORPORATION, TOKYO (JP)

(72) Inventors: TETSURO GOTO, TOKYO (JP); KEN KOBAYASHI, TOKYO (JP); HAYATO HASEGAWA, TOKYO (JP); YOSHIAKI SAKAKURA, TOKYO (JP); MANAMI MIYAWAKI, TOKYO (JP); KEI TSUKAMOTO, TOKYO (JP); NAOKI KAWAGUCHI, TOKYO (JP)

(21) Appl. No.: 19/471,624

(22) PCT Filed: Mar. 18, 2024
(86) PCT No.: PCT/JP2024/010431

§ 371 Date: Oct. 1, 2025

(30) Foreign Application Priority Data
Apr. 25, 2023 (JP) 2023-071464

(51) Int. Cl. B25J 9/16; B25J 13/08; B25J 15/08

(52) U.S. Cl. CPC B25J 9/1687; B25J 9/1694; B25J 13/082; B25J 15/08

(57) ABSTRACT

A robotic device according to an embodiment of the present technology is a robotic device which fits a piece of work into a socket including an opening surface perpendicular to a direction of a first axis, the robotic device including a hand portion, a sensor portion, and a control device. The hand portion includes a plurality of finger portions respectively including gripping surfaces with which the piece of work is graspable in a direction of a second axis, the second-axis direction being perpendicular to the first-axis direction. The sensor portion is provided to at least one of the plurality of finger portions, and is configured to be capable of detecting a distribution of a pressure acting on the gripping surface. The control device is configured to determine a direction of a moment that acts on the piece of work, on the basis of an output from the sensor portion that is obtained when the piece of work is pressed against the opening surface in the first-axis direction, and to generate, on the basis of the determined direction of the moment, a first control command used to correct a position of the hand portion such that the hand portion is at a position that enables the piece of work to be aligned with the socket in the first-axis direction.

### TECHNICAL FIELD

The present technology relates to a robotic device including a hand portion and a method for controlling the robotic device.

### BACKGROUND ART

In recent years, with a decline of a working population, automation of work using robots has been discussed in various situations. When performing a compliance task such as inserting a connector into a socket hole, for example, in a robot hand that grips an object at a factory, a store, and/or the like, positioning accuracy in a submillimeter order is required, so if a position of the gripped connector is deviated, there is a possibility that the connector will not be properly inserted into the socket hole. In this regard, as described in Patent Literature 1, for example, there is known a technology in which a piece of work (gripped object) is captured by a camera installed in the robot hand, and the captured image is processed to improve the accuracy in positioning the piece of work.

However, for the highly-accurate positioning using image processing, the piece of work needs to stay still for a certain period of time or more, thus causing lowering of a work takt. Further, there is a possibility that an image of the periphery of the piece of work will not be captured due to occlusion and/or the like if a camera position is not optimized due to an influence of a work environment or peripheral equipment. Furthermore, there is a problem that, since high-precision cameras are expensive and time-consuming adjustments and learning of the image processing are required every time a destination of the piece of work is changed, device costs and adjustment costs increase.

To address such problems, for example, Patent Literature 2 proposes a technology in which, by performing feedback control of an arm position and traveling direction by arranging a force sensor at a wrist portion of a hand and detecting a reaction force at a time a connector is inserted, a positional deviation can be compensated in real time. Further, Patent Literature 3 describes a technology in which a tactile sensor is attached to a hand to detect “prying” or “slipping” of a piece of work.

### CITATION LIST

### Patent Literature

Patent Literature 1: Japanese Patent Application Laid-open No. 2021-35706

Patent Literature 2: Japanese Patent Application Laid-open No. 2020-202090

Patent Literature 3: Japanese Patent Application Laid-open No. Sho 60-114493

### DISCLOSURE OF INVENTION

### Technical Problem

However, in the configuration in which the force sensor is arranged at the wrist portion of the hand, a reaction force at a tip of the hand is detected at the wrist portion, and thus there is a problem that accurate control is not performed due to an influence of noise caused by vibrations and inertia of the robot itself, particularly when handling a heavy end effector. Furthermore, Patent Literature 3 does not describe how the hand is controlled on the basis of the “prying” or “slipping” of the piece of work detected by the tactile sensor.

In view of the circumstances as described above, the present technology aims at providing a robotic device and a method for controlling the robotic device, the robotic device making it possible to position a connector with respect to a socket with high accuracy,.

### Solution to Problem

A robotic device according to an embodiment of the present technology is a robotic device which fits a piece of work into a socket including an opening surface perpendicular to a direction of a first axis, the robotic device including a hand portion, a sensor portion, and a control device.

The hand portion includes a plurality of finger portions respectively including gripping surfaces with which the piece of work is graspable in a direction of a second axis, the second-axis direction being perpendicular to the first-axis direction.

The sensor portion is provided to at least one of the plurality of finger portions, and is configured to be capable of detecting a distribution of a pressure acting on the gripping surface.

The control device is configured to determine a direction of a moment that acts on the piece of work, on the basis of an output from the sensor portion that is obtained when the piece of work is pressed against the opening surface in the first-axis direction, and to generate, on the basis of the determined direction of the moment, a first control command used to correct a position of the hand portion such that the hand portion is at a position that enables the piece of work to be aligned with the socket in the first-axis direction.

The control device may be configured to determine the direction of the moment about the second axis perpendicular to the gripping surface, and to generate, as the first control command and on the basis of the determined direction of the moment, a control command used to cause the hand portion to make a parallel movement in a direction of a third axis that is parallel to the gripping surface and orthogonal to the first axis and the second axis.

The sensor portion may be provided to each of the plurality of finger portions.

The control device may be configured to determine the direction of the moment about the third axis, and to generate, as the first control command and on the basis of the determined direction of the moment, a control command used to cause the hand portion to make a parallel movement in the second-axis direction.

The control device may be configured to further determine the direction of the moment acting on the piece of work, on the basis of the output from the sensor portion, the output being obtained when the piece of work is moved in the first-axis direction inside the socket, and to generate a second control command used to correct an attitude of the hand portion, on the basis of the determined direction of the moment.

The control device may be configured to determine the direction of the moment about the second axis perpendicular to the gripping surface, and to generate, as the second control command, a control command used to rotate the hand portion around a tip end of the piece of work about the second axis in a same direction as the determined direction of the moment.

The sensor portion may be provided to each of the plurality of finger portions.

The control device may be configured to determine a direction about a third axis that is parallel to the gripping surface and orthogonal to the first axis and the second axis, and to generate, as the second control command, a control command used to rotate the hand portion around the tip end of the piece of work about the third axis in the same direction as the determined direction of the moment.

The sensor portion may include an elastically deformable sensor sheet including a plurality of capacitive elements detecting the pressure acting on the gripping surface.

The sensor sheet may include a pressure sensor including a sensor electrode layer including the plurality of capacitive elements arrayed in a matrix, a reference electrode layer connected to a reference potential, and a deformation layer arranged between the sensor electrode layer and the reference electrode layer.

The sensor sheet may include
a pair of pressure sensors each including a sensor electrode layer including the plurality of capacitive elements arrayed in a matrix, a reference electrode layer connected to a reference potential, and a deformation layer arranged between the sensor electrode layer and the reference electrode layer, and
a separation layer arranged between pressure sensors of the pair of pressure sensors, the separation layer being formed of a viscoelastic material.

A robotic device controlling method according to an embodiment of the present technology is a method for controlling a robotic device which includes a hand portion including a plurality of finger portions respectively including gripping surfaces with which a piece of work is graspable in a second-axis direction perpendicular to a first-axis direction, and a sensor portion which is provided to at least one of the plurality of finger portions, the sensor portion being capable of detecting a distribution of a pressure acting on the gripping surface, the robotic device fitting the piece of work into a socket including an opening surface perpendicular to the first-axis direction, the method including:
determining a direction of a moment that acts on the piece of work, on the basis of an output from the sensor portion that is obtained when the piece of work is pressed against the opening surface in the first-axis direction; and
generating, on the basis of the determined direction of the moment, a control command used to move the hand portion to a position that enables the piece of work to be aligned with the socket in the first-axis direction.

### BRIEF DESCRIPTION OF DRAWINGS

FIG. 1 is a perspective view of a main portion showing a robotic device according to an embodiment of the present technology.

FIG. 2 is a schematic cross-sectional side view showing a cross-sectional structure of a sensor sheet as one configuration example of a sensor portion in the robotic device.

FIG. 3 is a schematic plan view showing a sensor electrode layer in the sensor sheet.

FIG. 4 is a plan view of a main portion showing one configuration example of a sensing portion in the sensor sheet.

FIG. 5 is a schematic cross-sectional side view showing a cross-sectional structure of a sensor sheet as another configuration example of the sensor portion.

FIG. 6 is a block diagram showing an example of a control system of the robotic device.

FIG. 7 is a side view illustrating an operation of the robotic device.

FIG. 8 is a plan view of the robotic device shown in FIG. 7.

FIG. 9 is a set of schematic side views illustrating a procedure of positioning a piece of work such that the piece of work is at a fitting position, the positioning being performed by the robotic device.

FIG. 10 is a flowchart showing an example of a processing procedure performed to execute the operations of the robotic device shown in FIG. 9.

FIG. 11 is a set of schematic plan views illustrating another procedure of positioning the piece of work such that the piece of work is at the fitting position, the positioning being performed by the robotic device.

FIG. 12 is a flowchart showing an example of a processing procedure performed to execute the operations of the robotic device shown in FIG. 11.

FIG. 13 is a diagram showing an example of a temporal change of detection values of the sensor portion.

FIG. 14 is a diagram showing an example of a distribution of a shear force detected by the sensor portion.

FIG. 15 is a flowchart showing another processing procedure performed to execute the operations of the robotic device.

FIG. 16 is a set of schematic side views illustrating a procedure of fitting the piece of work into a socket hole, the fitting being performed by the robotic device.

FIG. 17 is a flowchart showing an example of a processing procedure to execute the operations of the robotic device shown in FIG. 16.

FIG. 18 is a set of schematic side views illustrating another procedure of fitting the piece of work into the socket hole, the fitting being performed by the robotic device.

FIG. 19 is a flowchart showing an example of a processing procedure performed to execute the operations of the robotic device shown in FIG. 18.

FIG. 20 is a schematic side view illustrating a procedure of fitting the piece of work into the socket hole, the fitting being performed by the robotic device.

FIG. 21 is a schematic plan view of the main portion for explaining another action of the robotic device.

FIG. 22 is a schematic side view of the main portion for explaining another action of the robotic device.

### MODES FOR CARRYING OUT THE INVENTION

Hereinafter an embodiment according to the present technology will be described with reference to the drawings.

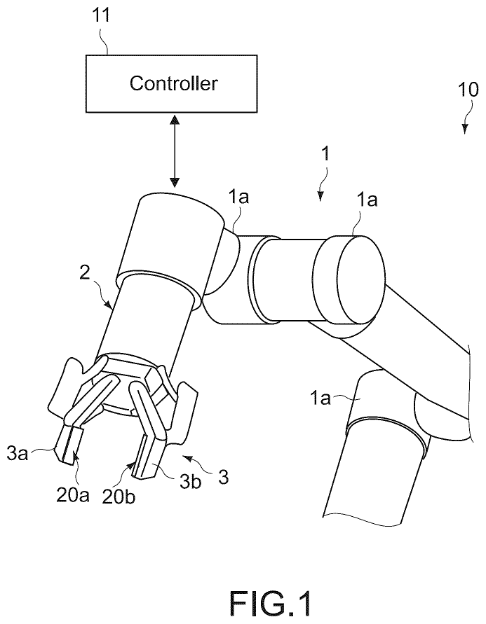

FIG. 1 is a perspective view of a main portion showing a robotic device 10 according to the embodiment of the present technology. In the present embodiment, the robotic device 10 is included in a robot hand. A configuration of the robotic device 10 will be roughly described below.

### Robotic Device

As shown in FIG. 1, the robotic device 10 includes an arm portion 1, a wrist portion 2, and a hand portion 3.

The arm portion 1 includes a plurality of joint portions 1a, and the hand portion 3 can be moved to an arbitrary position by driving the joint portions 1a. The wrist portion 2 is rotatably connected to the arm portion 1, and the hand portion 3 can be rotated by the rotation of the wrist portion 2.

The hand portion 3 includes a plurality of finger portions capable of gripping a gripping object (work). In the present embodiment, the hand portion 3 includes two finger portions 3a and 3b opposing each other, and is capable of gripping the piece of work between the two finger portions 3a and 3b by driving the two finger portions 3a and 3b. It is noted that the number of finger portions can be changed as appropriate to three, four or more, or the like.

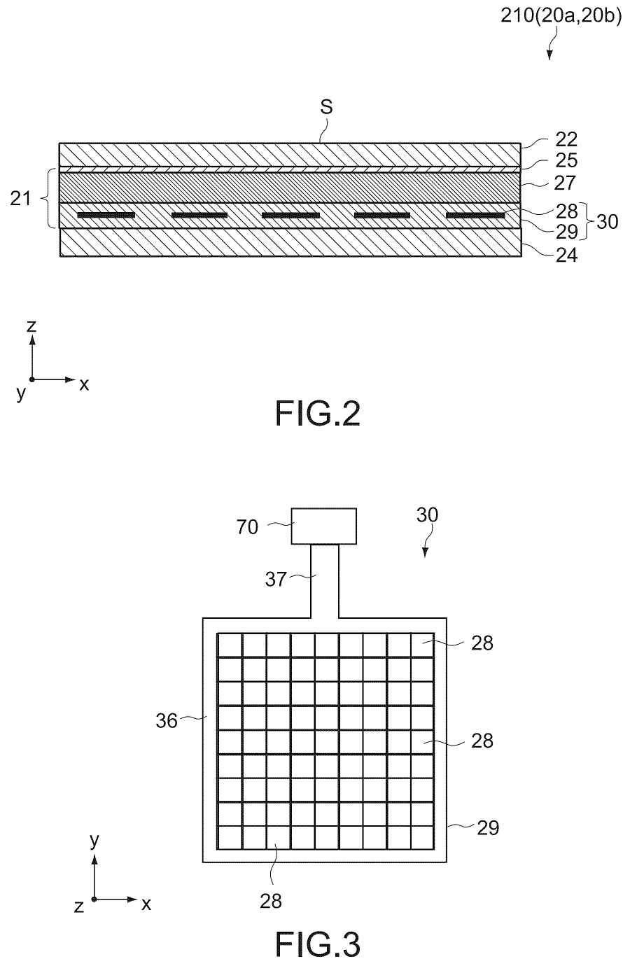

Sensor portions 20a and 20b are respectively provided on opposing surfaces of the two finger portions 3a and 3b. The sensor portions 20a and 20b each include a pressure detection surface and are each configured to be capable of detecting pressure components applied in a direction perpendicular to the pressure detection surface and an in-plane distribution thereof. Alternatively, the sensor portions 20a and 20b may each be a three-axis sensor capable of detecting not only the pressure distribution but also a shear force parallel to the pressure detection surface and an in-plane distribution thereof. The sensor portions 20a and 20b are provided to all of the finger portions 3a and 3b, but the sensor portion may alternatively be provided to only one of the finger portions. It is noted that the configuration of the sensor portions 20a and 20b will be described later with reference to FIG. 2 and the like.

The robotic device 10 is driven under control of a controller 11. The controller 11 includes a control portion, a storage portion, and the like. The control portion is, for example, a CPU (Central Processing Unit), and controls drive of the respective portions of the robotic device 10 on the basis of a program stored in the storage portion. The controller 11 may be a dedicated device in the robotic device 10, or may be a general-purpose device. The controller 11 may be, for example, a PC (Personal Computer) connected to the robotic device 10 by wires or wirelessly, a server device on a network, or the like. The controller 11 may be configured as a part of the robotic device 10.

### Sensor Portion

Next, the sensor portions 20a and 20b will be described in detail. The sensor portions 20a and 20b have the same configuration. As described above, the sensor portions 20a and 20b each include a sensor sheet capable of detecting the distribution of a pressure acting on the pressure detection surface.

### Configuration Example 1

FIG. 2 is a schematic cross-sectional side view showing a cross-sectional structure of a sensor sheet 210 as one configuration example of the sensor portions 20a and 20b. FIG. 3 is a schematic plan view showing a sensor electrode layer 30 in the sensor sheet 210.

In FIGS. 2 and 3, an x axis direction and a y axis direction are directions parallel to a pressure detection surface S of the sensor sheet 210 (hereinafter, will also be referred to as in-plane directions), and a z axis direction is a direction perpendicular to the pressure detection surface S (hereinafter, will also be referred to as a perpendicular direction). Also in FIG. 2, the upper side corresponds to a front side to which an external force is applied, and the lower side corresponds to a back side on the other side.

The sensor sheet 210 has a rectangular flat plate shape as a whole in a plan view. It is noted that the shape of the sensor sheet 210 in a plan view only needs to be set as appropriate according to a shape of a location where the sensor portions 20a and 20b are arranged, and the shape of the sensor sheet 210 in a plan view is not limited in particular. For example, the shape of the sensor sheet 210 in a plan view may be a polygon other than a square, a circle, an ellipse, or the like.

As shown in FIG. 2, the sensor sheet 210 includes a laminated body including a pressure sensor 21, a surface layer 22 arranged on an upper surface of the pressure sensor 21, and a support layer 24 arranged on a lower surface of the pressure sensor 21.

The pressure sensor 21 includes a sensor electrode layer 30, a reference electrode layer 25, and a deformation layer 27 arranged between the sensor electrode layer 30 and the reference electrode layer 25.

The sensor electrode layer 30 includes a flexible printed substrate or the like. As shown in FIG. 3, the sensor electrode layer 30 includes a main body portion 36 that is rectangular in a plan view, and a drawing portion 37 that extends outwardly from the main body portion 36. It is noted that the shape of the sensor electrode layer 30 in a plan view is not limited to the rectangular shape and can be changed as appropriate.

The sensor electrode layer 30 includes a flexible base material 29 and a plurality of sensing portions 28 provided on a surface of the base material 29 or inside the base material 29. As the material of the base material 29, a polymer resin such as polyethylene terephthalate, polyimide, polycarbonate, or acrylic resin is used, for example. The sensing portions 28 are regularly arrayed in a matrix at predetermined intervals in both the vertical and horizontal directions (vertical: y axis direction, horizontal: x axis direction). In the example shown in FIG. 3, the number of sensing portions 28 is 9×9 (vertical×horizontal) with a total of 81. It is noted that the number of sensing portions 28 can be changed as appropriate.

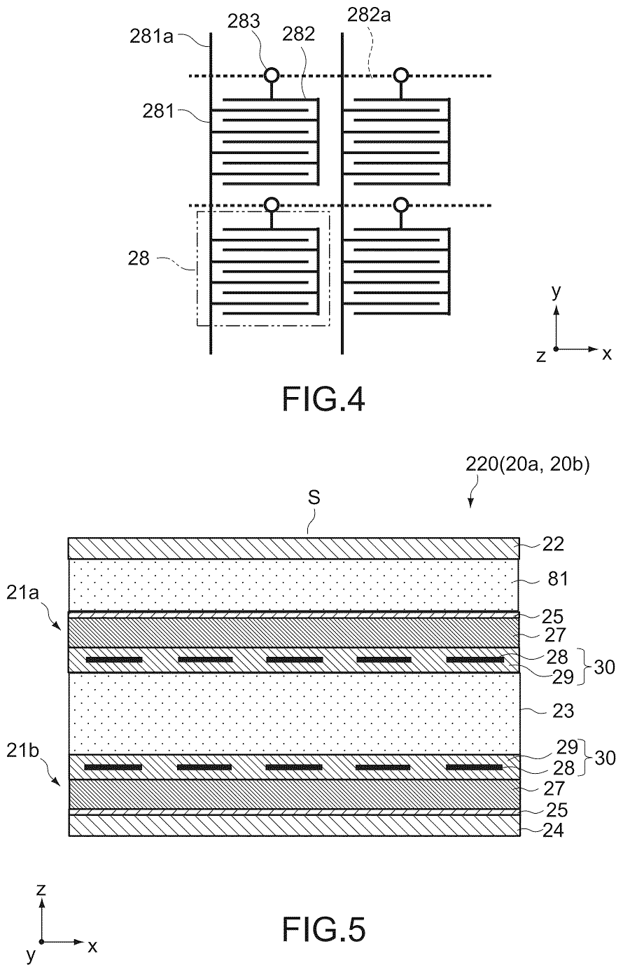

The sensing portions 28 include a plurality of capacitive elements (detection elements) capable of detecting a change in distance from the reference electrode layer 25 as a change in capacitance. As shown in FIG. 4, for example, the sensing portions 28 each include a comb-like pulse electrode 281 and a comb-like sense electrode 282. The comb-like pulse electrode 281 and the comb-like sense electrode 282 are arranged such that comb teeth thereof oppose each other, and each of the sensing portions 28 includes an area (node area) where the comb teeth of one of the electrodes each fit between the comb teeth of the other one of the electrodes. The pulse electrodes 281 are connected to wiring portions 281a extending in the y axis direction, and the sense electrodes 281 are connected to wiring portions 282a extending in the x axis direction. The wiring portions 281a are arrayed in the x axis direction on the front surface of the base material 29, and the wiring portions 282a are arrayed in the y axis direction on the back surface of the base material 29. The sense electrodes 282 are electrically connected to the wiring portions 282a via through-holes 283 provided to the base material 29. The sensor electrode layer 30 may include a ground line. For example, the ground line is provided at an outer circumferential portion of the sensor electrode layer 30 or at portions where the wiring portions 281a and 282a run in parallel.

It is noted that the structure of the sensing portion 28 is not limited to the example described above, and any structure may be used. For example, the sensor electrode layer 30 may include a laminated body of a first electrode sheet having a lattice-like first electrode pattern extending in the x axis direction and a second electrode sheet having a lattice-like second electrode pattern extending in the y axis direction. In this case, the sensing portions 28 are formed at intersection portions between the first electrode pattern and the second electrode pattern.

The reference electrode layer 25 is connected to a reference potential. In the present embodiment, the reference electrode layer 25 is a so-called ground electrode and is connected to a ground potential. The reference electrode layer 25 has flexibility, and a thickness thereof is, for example, about 0.05 mm to 0.5 mm. As the material of the reference electrode layer 25, for example, an inorganic conductive material, an organic conductive material, a conductive material containing both the inorganic conductive material and the organic conductive material, or the like is used.

Examples of the inorganic conductive material include metal such as aluminum, copper, and silver, alloys such as stainless steel, and metal oxides such as zinc oxide and indium oxide. Further, examples of the organic conductive material include carbon materials such as carbon black and carbon fibers, and conductive polymers such as substituted or unsubstituted polyaniline and polypyrrole. The reference electrode layer 25 may include a thin metal plate formed of stainless steel, aluminum, or the like, conductive fibers, conductive nonwoven fabric, or the like. The reference electrode layer 25 may be formed on a plastic film by, for example, a method such as vapor deposition, sputtering, adhesion, or application.

The deformation layer 27 is arranged between the sensor electrode layer 30 and the reference electrode layer 25. The deformation layer 27 has a thickness of, for example, about 100 μm to 1000 μm. The deformation layer 27 is configured to be elastically deformable with respect to an external force. When an external force is applied to the sensor sheet 210 in the perpendicular direction, the reference electrode layer 25 approaches the sensor electrode layer 30 while the deformation layer 27 is elastically deformed according to the external force. At this time, since the capacitance between the pulse electrode 281 and the sense electrode 282 in the sensing portion 28 changes, the sensing portion 28 can detect this change of the capacitance as a pressure value.

A thickness of the deformation layer 27 is, for example, larger than 100 um and equal to or smaller than 1000 um, and a basis weight of the deformation layer 27 is, for example, equal to or smaller than 50 mg/cm². By setting the thickness and basis weight of the deformation layer 27 within this range, detection sensitivity of the pressure sensor 22 in the perpendicular direction can be improved.

A lower limit value of the thickness of the deformation layer 27 is not limited in particular as long as it is larger than 100 μm, but this lower limit value may be, for example, 150 um or more, 200 um or more, 250 μm or more, 300 μm or more, or the like. Further, an upper limit value of the thickness of the deformation layer 27 is not limited in particular as long as it is 1000 μm or less, but this upper limit value may be, for example, 950 μm or more, 900 mμm or less, 850 μm or less, 800 μm or less, or the like.

In order to facilitate the deformation in the z axis direction, the deformation layer 27 may include a patterning structure including a columnar structure, for example. As this patterning structure, various structures such as a matrix pattern, a stripe pattern, a mesh pattern, a radial pattern, a geometric pattern, and a spiral pattern can be adopted.

The surface layer 22 is formed of an arbitrary material having flexibility, such as a plastic film, woven fabric, nonwoven fabric, rubber, and leather. The surface layer 22 may be configured as a contact surface that comes into contact with a piece of work when the robotic device 10 grips the piece of work with the finger portions 3a and 3b. In this case, since the surface layer 22 functions as the pressure detection surface that receives a load (a reaction force of a gripping force) applied from the piece of work during the gripping operation, it is favorable for the surface layer 22 to have a surface property with which a frictional force of a predetermined level or more is provided between the surface layer 22 and the piece of work in order to stably grip the piece of work.

The support layer 24 supports the pressure sensor 21 and functions as, for example, a bonding layer for fixing the pressure sensor 21 to each of the surfaces of the finger portions 3a and 3b. The support layer 24 is, for example, an adhesive layer such as a double-sided tape.

Mounted on the drawing portion 37 of the sensor electrode layer 30 is a control unit 70 which calculates a force in the in-plane direction on the basis of information on the pressure detected by the pressure sensor 21. The control unit 70 is typically a computer including a CPU (Central Processing Unit), and includes an integrated circuit such as an IC chip. The control unit 70 is mounted on the sensor electrode layer 30 (drawing portion 37) and is configured to drive the pressure sensor 21 and receive an input of an output signal from the pressure sensor 21. It is noted that the control unit 70 is not limited to the example of being mounted on the sensor electrode layer 30.

### Configuration Example 2

FIG. 5 is a schematic cross-sectional side view showing a cross-sectional structure of a sensor sheet 220 as another configuration example of the sensor portions 20a and 20b. It is noted that portions corresponding to those of Configuration Example 1 are denoted by the same symbols, and detailed descriptions thereof will be omitted.

The sensor sheet 220 includes a first pressure sensor 21a on the front side (work side), a second pressure sensor 21b on the back side (finger portions 3a and 3b side), and a separation layer 23 arranged between the first pressure sensor 21a and the second pressure sensor 21b. That is, the sensor sheet 220 has a structure in which the second pressure sensor 21b, the separation layer 23, and the first pressure sensor 21a are laminated in the stated order from the lower layer side in the perpendicular direction. The first pressure sensor 21a and the second pressure sensor 21b have a configuration similar to or substantially similar to that of the pressure sensor 21 described above, so descriptions thereof will be omitted.

The sensor sheet 220 further includes a viscoelastic layer 81 arranged on the upper side (front surface side) of the first pressure sensor 21a. The viscoelastic layer 81 is formed of a material that can be deformed according to an external force, such as silicone gel, urethane gel, synthetic rubber, and foam, for example. It is noted that the viscoelastic layer 81 may be omitted as necessary.

The sensor sheet 220 detects a force applied to the sensor sheet 220 in the in-plane direction (shear force Fs), on the basis of a center-of-pressure position (pressure detection position) in the in-plane direction by the first pressure sensor 21a and a center-of-pressure position (pressure detection position) in the in-plane direction by the second pressure sensor 21b. The sensor sheet 220 also detects a force applied to the sensor sheet 220 from above in the perpendicular direction (load Fz), on the basis of a value of the pressure detected by the first pressure sensor 21a.

The separation layer 23 is fixed between the first pressure sensor 21a and the second pressure sensor 21b via an adhesive layer (not shown). The separation layer 23 is formed of a viscoelastic material that is deformed by a load applied to the first pressure sensor 21a via the surface layer 22 and the viscoelastic layer 81. Examples of this type of viscoelastic material include silicone gel, urethane gel, synthetic rubber, and foam. The thickness of the separation layer 23 is not limited in particular and is, for example, 1000 μm or more and 5000 μm or less, and is set according to the thickness of the viscoelastic layer 81, and the like. The planar shape of the separation layer 23 is not limited in particular and is typically rectangular or circular.

### Control Device

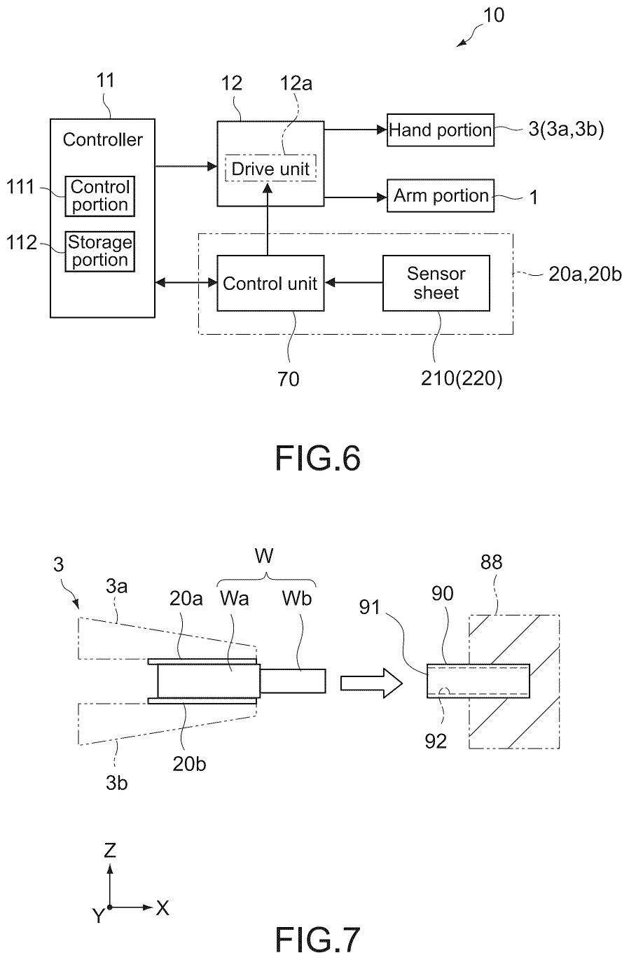

FIG. 6 is a block diagram showing an example of a control system of the robotic device 10.

The robotic device 10 includes the controller 11 and a drive portion 12 that drives the arm portion 1, the hand portion 3, and the like. The drive portion 12 includes a drive unit 12a that drives the finger portions 3a and 3b. The controller 11 is configured to be capable of executing, on the basis of input signals from various sensors, a control program for causing the robotic device 10 to operate.

Each of the sensor portions 20a and 20b is included in one of the various sensors and attached to a gripping surface of the hand portion 3 for gripping a piece of work. On the basis of a control command from the controller 11, the sensor portions 20a and 20b output a gripping command for gripping the piece of work to the drive unit 12a that drives the finger portions 3a and 3b of the hand portion 3. The sensor portions 20a and 20b each detect a pressing force (pressure distribution, gripping force (vertical load), or shear force) acting on the pressure detection surface S, calculate a value of the pressing force in the control unit 70, and input the value to the controller 11. The controller 11 generates various control commands (drive signals) for controlling positions and attitudes of the arm portion 1 and the hand portion 3 (finger portions 3a and 3b), and outputs the control commands to the drive portion 12. The drive portion 12 is typically an actuator such as an electric motor or a fluid pressure cylinder, and drives the arm portion 1, the hand portion 3, and the like on the basis of the drive signals from the controller 11.

The controller 11 includes a control portion 111 and a storage portion 112. The control portion 111 is, for example, a CPU (Central Processing Unit), and, on the basis of the sensor signal from the control unit 70, the control portion 111 executes the program stored in the storage portion 112 to control the drive of the respective portions in the arm portion 1 and the hand portion 3. Typically, the control unit 70 acquires information regarding forces in three axial directions, that have been detected by the sensor sheet 210 (220), and outputs these pieces of information to the controller 11 as the sensor signal. Based on this sensor signal, the controller 11 controls the drive of the arm portion 1 and the hand portion 3 so that an object is stably gripped with an appropriate gripping force and the position and attitude of the hand portion 3 are set to a predetermined position and attitude to be described later.

In the present embodiment, the controller 11 and the control unit 70 are configured as a control device that detects a stress distribution or a shear force that acts on the gripping surface (pressure detection surface S), on the basis of the output from the sensor sheet 210 (220), and generates control commands to change the position and attitude of the hand portion 3.

The storage portion 112 includes a non-volatile memory that stores various programs and data requisite for processing by the control portion 111, and a volatile memory that is used as a working area for the control portion 111. The various programs may be read from a portable recording medium such as a semiconductor memory, or may be downloaded from a server device on a network.

The control unit 70 is electrically connected to the sensor sheet 210 (220) and is configured to calculate, on the basis of the output from the sensor sheet 210 (220), the pressure acting on each of the finger portions 3a and 3b and the in-plane distribution thereof. Further, the control unit 70 is electrically connected to the controller 11, and the control unit 70 outputs the calculated pressure and in-plane distribution thereof to the controller 11, and outputs a gripping command to the drive unit 12a that drives the finger portions 3a and 3b of the hand portion 3, on the basis of the control command from the controller 11.

The controller 11 and the control unit 70 are configured as a control device that controls operations of the hand portion 3. In the present embodiment, the gripping command to be supplied to the drive unit 12a that drives the finger portions 3a and 3b is generated by the control unit 70, but instead, the controller 11 that controls the overall operations of the robotic device 10 may generate the gripping command. In this case, the controller 11 is configured as the control device described above.

### Control of Robotic Device

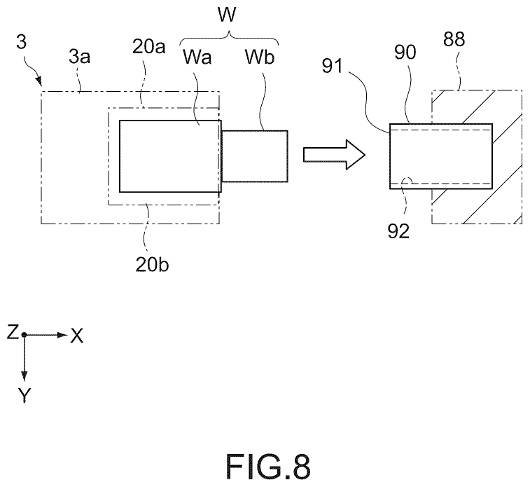

FIG. 7 is a side view illustrating the operation of the robotic device 10, and FIG. 8 is a plan view thereof. In each figure, the X axis, the Y axis, and the Z axis indicate three axial directions orthogonal to one another in real space. Herein, the X axis direction is a front-rear direction, the Y axis direction is a left-right direction, and the Z axis direction is a height direction. The robotic device 10 according to the present embodiment is configured as an assembly robot that fits a piece of work W into a fitting hole (hereinafter, socket hole 92) of a socket 90 supported by a support portion 88.

In FIG. 7, the piece of work W is a connector component including a main body portion Wa and a terminal portion Wb. For example, the main body portion Wa is a resin member of a rectangular parallelepiped shape that has a length direction in the X axis direction, a width direction in the Y axis direction, and a thickness direction in the Z axis direction, and the terminal portion Wb is a metal member similarly of a rectangular parallelepiped shape that protrudes in the X axis direction from a tip end portion of the main body portion Wa.

Meanwhile, the socket 90 includes an opening surface (opening end portion) 91 where the socket hole 92 is opened, and is supported by the support portion 88 such that the opening surface 91 becomes orthogonal to the X axis direction. The support portion 88 may be a part of a device equipped with the socket 90, or may be another robot hand gripping the socket 90. The socket hole 92 has an opening shape corresponding to an outer shape of the terminal portion Wb, and a depth of the socket hole 92 is not limited in particular and may be formed in a size that corresponds to the length of the terminal portion Wb. By fitting the terminal portion Wb into the socket hole 92, the piece of work W is mechanically and electrically connected to the socket 90.

As shown in FIG. 7, the controller 11 causes the hand portion 3 gripping the piece of work W to make a parallel movement in the X axis direction from a state where the piece of work W and the socket 90 are arranged to oppose each other at a predetermined distance in the X axis direction, to thus fit the terminal portion Wb of the piece of work W into the socket hole 92. In the positioning task of the piece of work W with respect to the socket 90 as shown in the figure, the position of the hand portion 3 is adjusted on the basis of preset coordinate values in the XYZ space. Alternatively, in place of or in addition to this, a camera may be installed in the hand portion 3 so that the position of the hand portion 3 is adjusted on the basis of image information from the camera.

Herein, positioning accuracy of a submillimeter order is generally required between the connector and the socket. Therefore, even if the hand portion 3 is caused to make a parallel movement in the X axis direction from the state shown in FIG. 7, there is a possibility that the terminal portion Wa of the piece of work W will not properly fit into the socket hole 92 and will stop in a state where a tip end of the terminal portion Wa is abutted against the opening surface 91 of the socket 90. In the present embodiment, assuming such a state, the controller 11 executes the following control.

### Control Example 1: Positioning Control Before Fitting

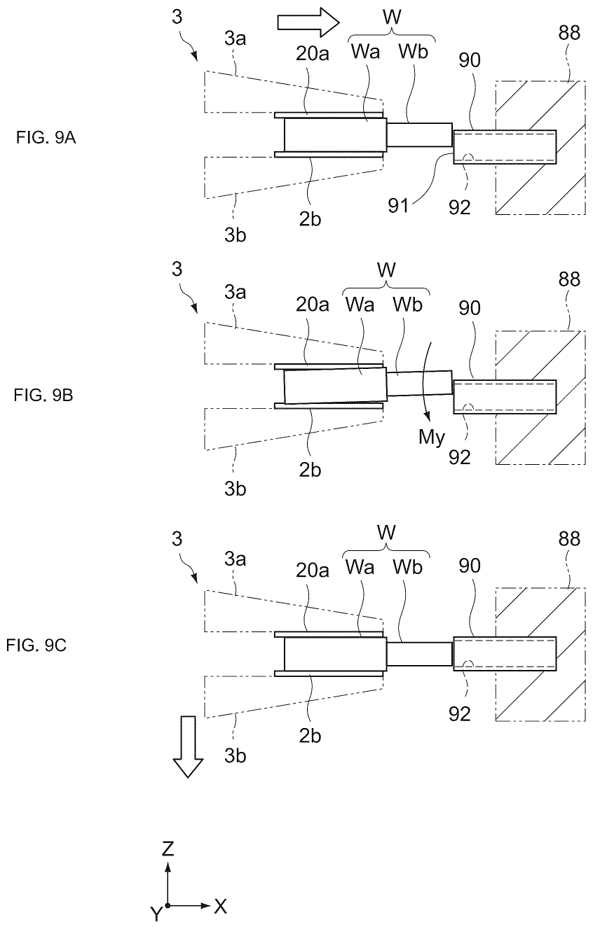

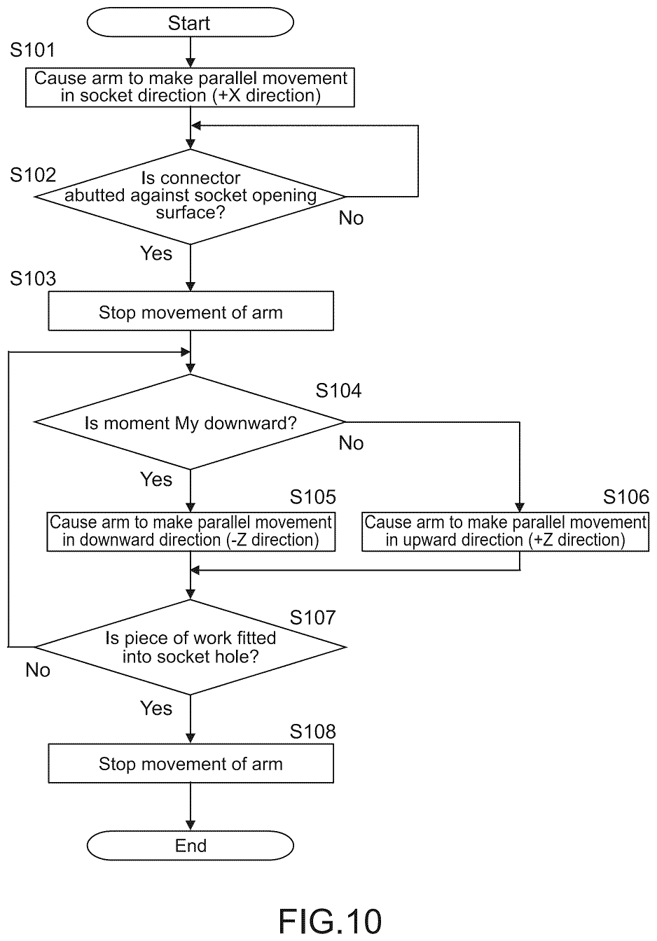

FIG. 9 is a set of schematic side views illustrating a procedure of positioning the piece of work W such that the piece of work W is at the fitting position, the positioning being performed by the robotic device 10, and FIG. 10 is a flowchart showing an example of a processing procedure performed by the controller 11 to execute the operations of the robotic device 10 shown in FIG. 9. It is noted that A and B of FIG. 9 each show a state where the terminal portion Wb of the piece of work W is abutted against the opening surface 91 of the socket 90 at a position that is slightly deviated upwardly (+Z direction) from the fitting position with the socket hole 92. Herein, to help understand the descriptions, it is assumed that, in the figures, there is no positional deviation of the piece of work W with respect to the fitting position with the socket hole 92 in the left-right direction (Y axis direction).

The controller 11 generates a movement command used to cause the arm portion 1 (synonymous with the hand portion 3; the same holds true in descriptions below) to make a parallel movement in the +X direction from the position shown in FIG. 7 at which the hand portion 3 opposes the socket 90, to thus cause the hand portion 3 to approach the socket 90 (ST101). Next, the controller 11 determines whether the terminal portion Wb of the piece of work W is abutted against the opening surface 91 of the socket 90 (ST102). The determination on whether the terminal portion Wb is abutted against the opening surface 91 is performed on the basis of whether a scalar value of a shear vector that acts on the sensor portions 20a and 20b at the time of the abutment of the terminal portion Wb and the opening surface 91 has exceeded a predetermined threshold value, and when the scalar value has exceeded the threshold value, it is determined that the terminal portion Wb is abutted against the opening surface 91. When determining that the terminal portion Wb is abutted against the opening surface 91 (Yes in ST102), the controller 11 stops the movement of the arm portion 1 (ST103).

As shown in A of FIG. 9, in a state where the terminal portion Wb of the piece of work W is pressing the opening surface 91 of the socket 90 (an upper edge portion of the socket hole 92) in the X axis direction, a moment My in a counterclockwise direction acts on the piece of work W about the Y axis parallel to the pressure detection surfaces S of the sensor portions 20a and 20b such that an end portion (lower edge portion) of the terminal portion Wb on the socket hole 92 side slides into the inside of the socket hole 92.

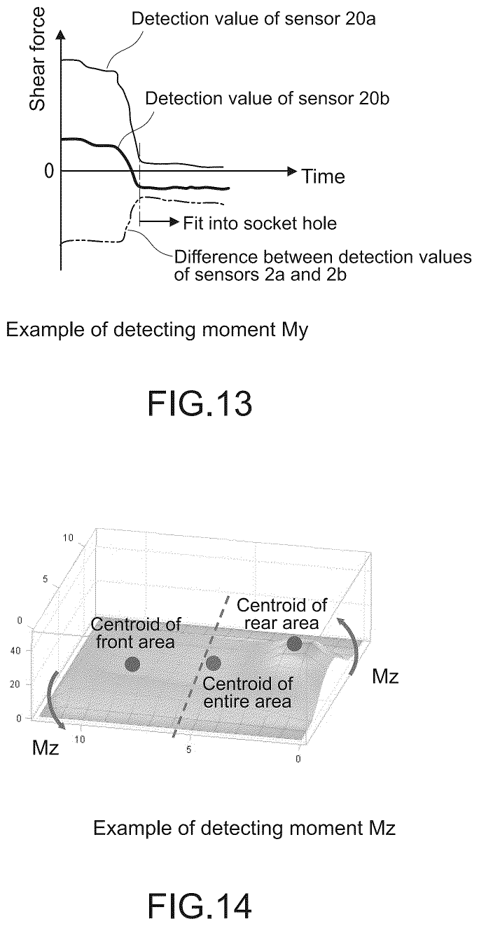

Stress distributions (shear forces) of the sensor portions 20a and 20b when the moment My acts on the piece of work W differ from each other. While an increase in stress is detected in a front area closer to the terminal portion Wb than a center position of the pressure detection surface S in the sensor portion 20a as one of the sensor portions, an increase in stress is detected in a rear area farther from the terminal portion Wb than the center position of the pressure detection surface S in the sensor portion 20b as the other one of the sensor portions. Typically, a magnitude of the shear force detected by the sensor portions 20a and 20b differs depending on the direction of the moment My. In this regard, the direction of the moment My can be determined by calculating a difference between the detection values of the sensor portions 20a and 20b. FIG. 13 shows an example of a temporal change of the detection values of the sensor portions 20a and 20b.

Next, on the basis of the direction of the moment My determined on the basis of the output from the sensor portions 20a and 20b as described above, the controller 11 generates a control command (first control command) used to correct the position of the hand portion 3 such that the hand portion 3 is at a position that enables the piece of work W to be aligned with the socket 90 in the X axis direction.

Specifically, the controller 11 determines whether the moment My is downward in B of FIG. 9 (ST104), and when it is determined that the moment My is downward, generates a movement command used to cause the arm portion 1 to make a parallel movement in the downward direction (−Z direction) (ST105). It is noted that conversely, when it is determined that the moment My is upward, a movement command used to cause the arm portion 1 to make a parallel movement in the upward direction (+Z direction) is generated (ST106). The parallel movement of the arm portion 1 in the up-down direction continues until the terminal portion Wb of the piece of work W is fitted into the socket hole 92.

Next, the controller 11 determines whether the terminal portion Wb of the piece of work W is fitted into the socket hole 92 (ST107). When the terminal portion Wb is fitted into the socket hole 92, the scalar value of the shear force detected by the sensor portions 20a and 20b becomes equal to or smaller than the predetermined threshold value (see FIG. 13). In this regard, the controller 11 continues the parallel movement of the arm portion 1 until the scalar value becomes equal to or smaller than the threshold value, and stops the parallel movement of the arm portion 1 when determining that the scalar value has become equal to or smaller than the threshold value (ST108). Accordingly, the piece of work W is determined with high accuracy to be at a position at which the piece of work W is aligned with the socket 90 in the X axis direction.

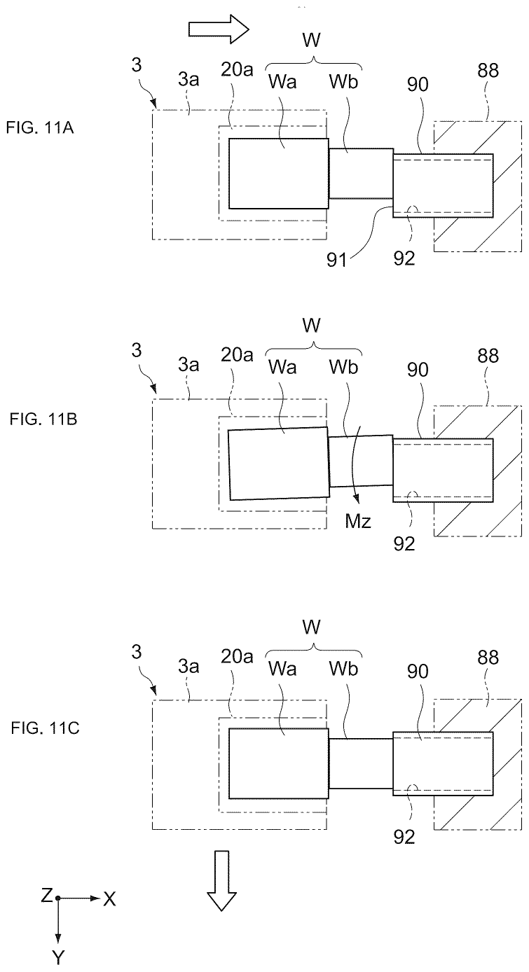

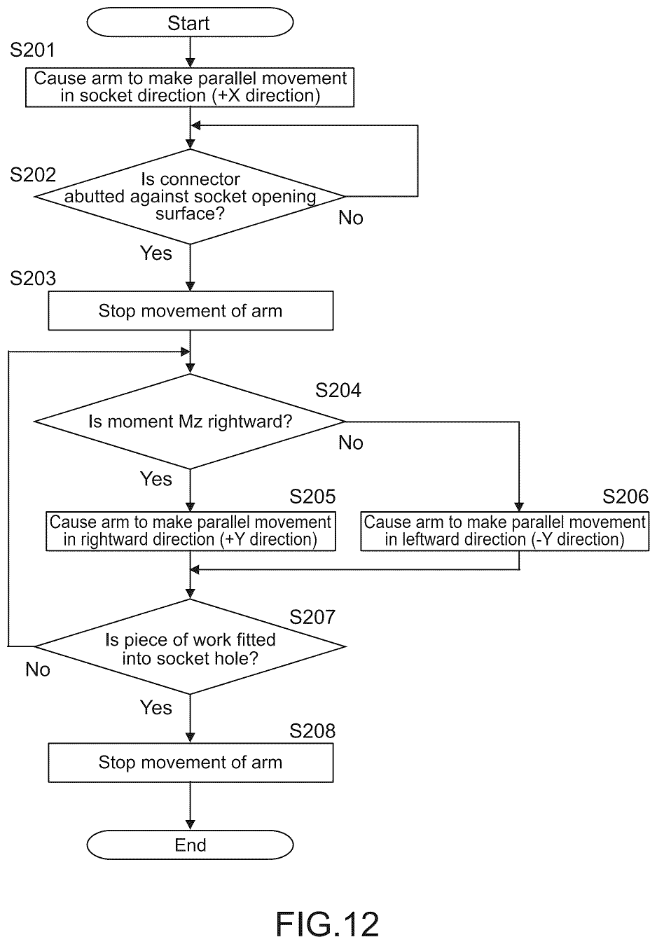

Next, FIG. 11 is a set of schematic plan views illustrating another procedure of positioning the piece of work W such that the piece of work W is at the fitting position, the positioning being performed by the robotic device 10, and FIG. 12 is a flowchart showing an example of a processing procedure performed by the controller 11 to execute the operations of the robotic device 10 shown in FIG. 11. It is noted that A and B of FIG. 11 are schematic plan views each showing a state where the terminal portion Wb of the piece of work W is abutted against the opening surface 91 of the socket 90 at a position slightly deviated to the left (−Y direction) from the fitting position with the socket hole 92. Herein, to help understand the descriptions, it is assumed that, in the figures, there is no positional deviation of the piece of work W with respect to the fitting position with the socket hole 92 in the up-down direction (Z axis direction).

The controller 11 generates a movement command used to cause the arm portion 1 to make a parallel movement in the +X direction from the position shown in FIG. 7 at which the hand portion 3 opposes the socket 90, to thus cause the hand portion 3 to approach the socket 90 (ST201). Next, the controller 11 determines whether the terminal portion Wb of the piece of work W is abutted against the opening surface 91 of the socket 90 (ST202), and when determining that the terminal portion Wb is abutted against the opening surface 91, stops the movement of the arm portion 1 (ST203).

As shown in FIG. A of 11, in a state where the terminal portion Wb of the piece of work W is pressing the opening surface 91 of the socket 90 (a left edge portion of the socket hole 92 when viewed from the piece of work W) in the X axis direction, a moment Mz in the counterclockwise direction acts on the piece of work W about the Z axis perpendicular to the pressure detection surfaces S of the sensor portions 20a and 20b such that the end portion (right end portion portion) of the terminal portion Wb on the socket hole 92 side slides into the inside of the socket hole 92.

The stress distributions (shear forces) of the sensor portions 20a and 20b when the moment Mz acts on the piece of work W are equivalent, and a shear force about the axis perpendicular to the pressure detection surface S is detected in each of the sensor portions 20a and 20b. That is, a shear force that acts about a centroid position in the front area closer to the terminal portion Wb than the center position of the pressure detection surface S of the sensor portions 20a and 20b and a shear force that acts about a centroid position in the rear area farther from the terminal portion Wb than the center position of the pressure detection surface S are detected. FIG. 14 shows an example of the distribution of a shear force detected in the sensor portions 20a and 20b.

It is noted that a difference between the shear force in the front area and the shear force in the rear area of the sensor portions 20a and 20b may be obtained to determine the direction of the moment Mz. Moreover, in determining the moment Mz, the output from one of the sensors 20a and 20b may be referenced, or an average value or maximum value of the outputs of both of the sensor portions may be referenced.

Next, on the basis of the direction of the moment Mz determined on the basis of the output from the sensor portions 20a and 20b as described above, the controller 11 generates a control command (first control command) used to correct the position of the hand portion 3 such that the hand portion 3 is at a position that enables the piece of work W to be aligned with the socket 90 in the X axis direction.

Specifically, the controller 11 determines whether the moment Mz is rightward (downward in B of FIG. 11) (ST204), and when determining that the moment Mz is rightward, generates a movement command used to cause the arm portion 1 to make a parallel movement in the rightward direction (+Y direction) (ST205). It is noted that conversely, when it is determined that the moment Mz is leftward, a movement command used to cause the arm portion 1 to make a parallel movement in the leftward direction (−Y direction) is generated (ST206). The parallel movement of the arm portion 1 in the left-right direction continues until the terminal portion Wb of the piece of work W is fitted into the socket hole 92.

Next, the controller 11 determines whether the terminal portion Wb of the piece of work W is fitted into the socket hole 92 (ST207). When the terminal portion Wb is fitted into the socket hole 92, the scalar value of the shear force detected by the sensor portions 20a and 20b becomes equal to or smaller than the predetermined threshold value. In this regard, the controller 11 continues the parallel movement of the arm portion 1 until the scalar value becomes equal to or smaller than the threshold value, and stops the parallel movement of the arm portion 1 when determining that the scalar value has become equal to or smaller than the threshold value (ST208). Accordingly, the piece of work W is determined with high accuracy to be at a position at which the piece of work W is aligned with the socket 90 in the X axis direction.

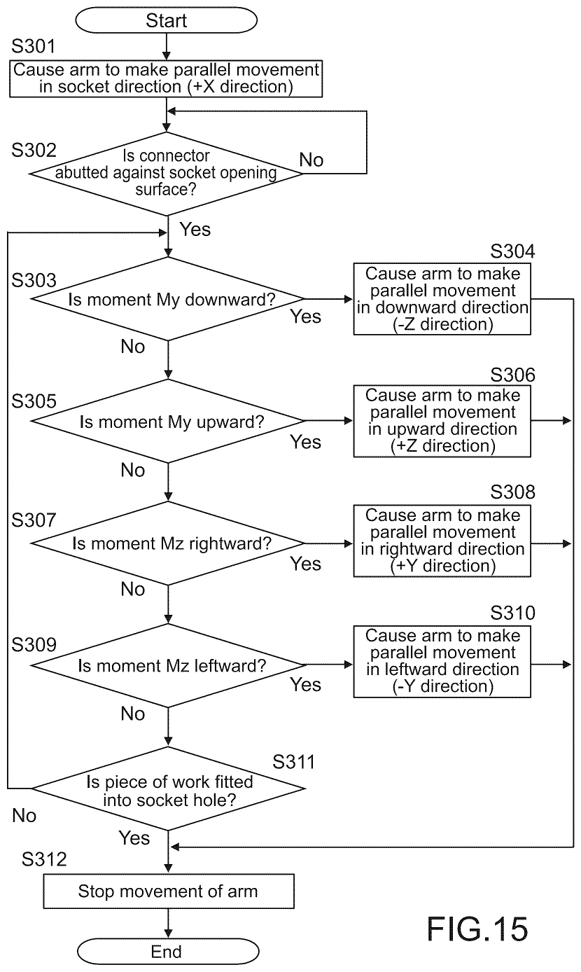

FIG. 15 is a flowchart showing an example of a processing procedure in which the positioning control in the up-down direction and the positioning control in the left-right direction, that have been described above, are integrated.

Herein, descriptions will be given on a procedure in which the directions of the moments My and Mz acting on the piece of work W are determined individually, and a relative position of the piece of work W with respect to the socket hole 92 is corrected while adjusting the movement direction of the arm portion 1 in accordance with the determination result.

The controller 11 generates a movement command used to cause the arm portion 1 to make a parallel movement in the +X direction from the position shown in FIG. 7 at which the hand portion 3 opposes the socket 90, to thus cause the hand portion 3 to approach the socket 90 (ST301). Next, the controller 11 determines whether the terminal portion Wb of the piece of work W is abutted against the opening surface 91 of the socket 90 (ST302), and when determining that the terminal portion Wb is abutted against the opening surface 91, stops the movement of the arm portion 1 (ST303).

Next, the controller 11 determines whether the moment My acting on the piece of work W is downward (ST303), and when determining that the moment My is downward, causes the arm portion 1 to make a parallel movement in the downward direction (−Z direction) (ST304). On the other hand, when the moment My acting on the piece of work W is upward, the controller 11 causes the arm portion 1 to make a parallel movement in the upward direction (+Z direction) (ST303, 304).

On the other hand, when the moment acting on the piece of work W is the moment Mz about the Z axis, the controller 11 determines whether the moment Mz is rightward (ST307). When determining that the moment Mz is rightward, the controller 11 causes the arm portion 1 to make a parallel movement the rightward direction (+Y direction) (ST308), and when determining that the moment Mz is leftward, causes the arm portion 1 to make a parallel movement in the leftward direction (−Y direction) (ST309, 310).

The parallel movement of the arm portion 1 in the up-down direction or the left-right direction continues until the terminal portion Wb of the piece of work W is fitted into the socket hole 92. Then, when it is determined that the terminal portion Wb is fitted into the socket hole 92, the movement of the arm portion 1 is stopped (ST311, 312). Accordingly, the piece of work W is determined with high accuracy to be at a position at which the piece of work W is aligned with the socket 90 in the X axis direction.

### Control Example 2: Attitude Control After Fitting

By causing the arm portion 1 to make a parallel movement in the +X direction after completing the correction control of the position of the terminal portion Wb of the piece of work W with respect to the socket hole 92 as described above, it is possible to fit the terminal portion Wb into the socket hole 92. However, due to a slight deviation of axial centers of the piece of work W and the socket hole 92, individual differences in the shapes of the terminal portion Wb and the socket hole 92, and the like, prying may act on the piece of work W about the Y axis or the Z axis when the piece of work W is fitted into the socket hole 92. The prying is detected as the moments My and Mz acting on the piece of work W during fitting, and the prying can be suppressed by correcting the attitude of the piece of work W in accordance with the directions of these moments My and Mz.

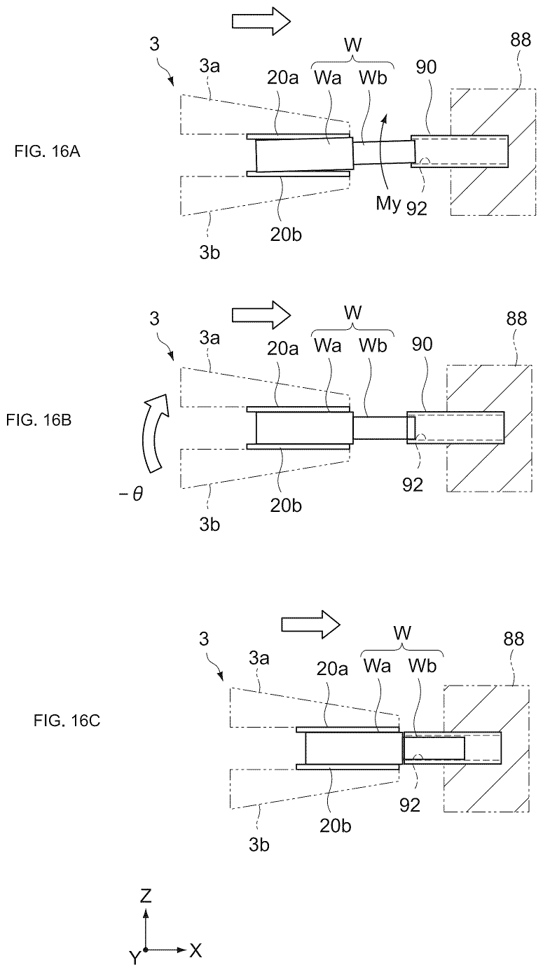

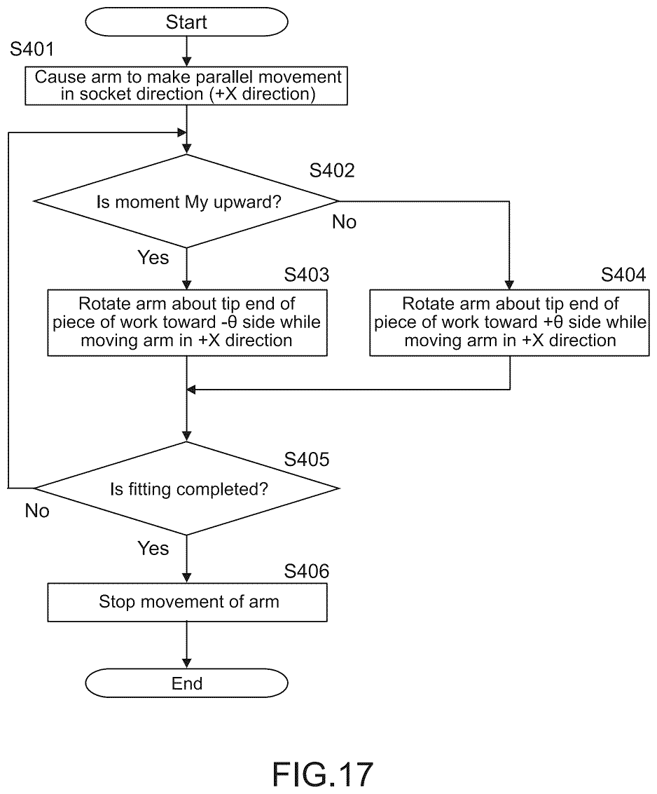

FIG. 16 is a set of schematic side views illustrating a procedure of fitting the piece of work W into the socket hole 92, the fitting being performed by the robotic device 10, and FIG. 17 is a flowchart showing an example of a processing procedure performed by the controller 11 to execute the operations of the robotic device 10 shown in FIG. 16. It is noted that A and B of FIG. 16 each show a state where the terminal portion Wb is fitted into the socket hole 92 in a state where the axial center of the piece of work W is tilted downwardly at a minute angle about the Y axis with respect to the axial center of the socket hole 92.

The controller 11 generates a movement command used to cause the arm portion 1 to make a parallel movement in the +X direction from the state shown in Fig. A of 16, to thus starting fitting of the terminal portion Wb of the piece of work W into the socket hole 92 (ST401).

Even while executing the fitting operation of the terminal portion Wb into the socket hole 92, the controller 11 determines presence or absence and direction of the moment acting on the piece of work W, on the basis of the detection values of the sensor portions 20a and 20b. That is, the controller 11 further determines the direction of the moment acting on the piece of work W, on the basis of the output from the sensor portions 20a and 20b, the output being obtained when the piece of work W is moved in the X axis direction inside the socket 90, and generates a control command (second control command) used to correct the attitude of the hand portion 3, on the basis of the determined direction of the moment.

In the state shown in Fig. A of 16, when the arm portion is moved in the +X direction, the moment My (prying) about the Y axis acts on the piece of work W. The controller 11 detects this moment My and determines whether the direction of the moment My is upward (ST402). When determining that the direction of the moment My is upward, the controller 11 generates a control command used to rotate, around a tip end of the terminal portion Wb of the piece of work W, the arm portion 1 upwardly (−θ side) in the same direction as the moment My, while moving the arm portion 1 in the +X direction (ST403). This allows the hand portion 3 to rotate in a direction in which the axial center of the piece of work W coincides with the axial center of the socket hole 92 as shown in Fig. B of 16 . The upward rotational movement of the arm portion 1 continues until the magnitude of the moment My becomes equal to or smaller than a predetermined value.

It is noted that conversely, when determining that the direction of the moment My is downward, the controller 11 generates a control command used to rotate, around the tip end of the terminal portion Wb of the piece of work W, the arm portion 1 downwardly (+θ side) in the same direction as the moment My, while moving the arm portion 1 in the +X direction (ST404).

Next, the controller 11 determines whether the task of fitting the piece of work W into the socket hole 92 is completed (ST405). The determination on whether the task of fitting the piece of work W into the socket hole 92 is completed is made on the basis of whether the scalar value of the shear vector acting on the sensor portions 20a and 20b has exceeded the predetermined threshold value described above. When determining that the task of fitting the piece of work W into the socket hole 92 is completed (Yes in ST405), the controller 11 stops the parallel movement of the arm portion 1 in the +X direction (ST406).

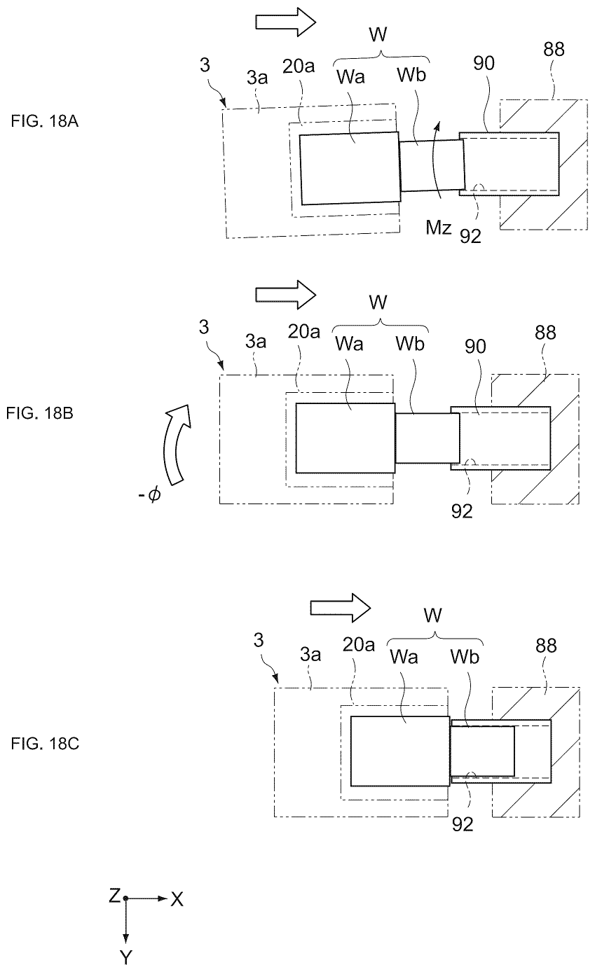

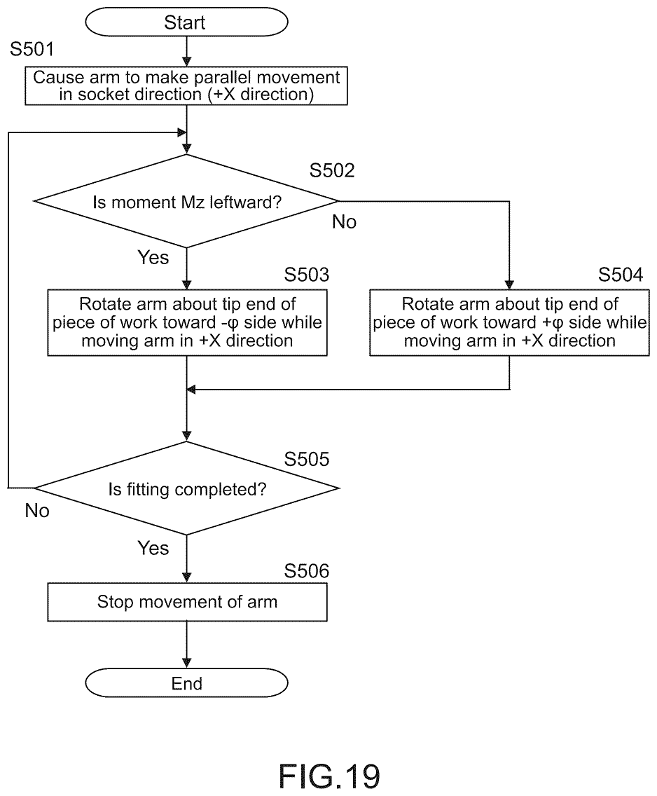

Next, FIG. 18 is a set of schematic side views illustrating another procedure of fitting the piece of work W into the socket hole 92, the fitting being performed by the robotic device 10, and FIG. 19 is a flowchart showing an example of a processing procedure performed by the controller 11 to execute the operations of the robotic device 10 shown in FIG. 18. It is noted that A and B of FIG. 18 each show a state where the terminal portion Wb is fitted into the socket hole 92 in a state where the axial center of the piece of work W is tilted toward the right at a minute angle about the Z axis with respect to the axial center of the socket hole 92.

The controller 11 generates a movement command used to cause the arm portion 1 to make a parallel movement in the +X direction from the state shown in A of FIG. 18, to thus start the fitting of the terminal portion Wb of the piece of work W into the socket hole 92 (ST501).

In the state shown in A of FIG. 18, when the arm portion is moved in the +X direction, the moment Mz (prying) about the Z axis acts on the piece of work W. The controller 11 detects this moment Mz and determines whether the direction of the moment Mz is leftward (ST502). When determining that the direction of the moment Mz is leftward, the controller 11 generates a control command used to rotate, around the tip end of the terminal portion Wb of the piece of work W, the arm portion 1 leftward (−φ side) in the same direction as the moment Mz, while moving the arm portion 1 in the +X direction (ST503).

This allows the hand portion 3 to rotate in the direction in which the axial center of the piece of work W coincides with the axial center of the socket hole 92 as shown in B of FIG. 18. The leftward rotational movement of the arm portion 1 continues until the magnitude of the moment Mz becomes equal to or smaller than a predetermined value.

It is noted that conversely, when determining that the direction of the moment Mz is rightward, the controller 11 generates a control command used to rotate, around the tip end of the terminal portion Wb of the piece of work W, the arm portion 1 rightward (+φ side) in the same direction as the moment Mz, while moving the arm portion 1 in the +X direction (ST504).

Next, the controller 11 determines whether the task of fitting the piece of work W into the socket hole 92 is completed (ST505). When determining that the task of fitting the piece of work W into the socket hole 92 is completed (Yes in ST505), the controller 11 stops the parallel movement of the arm portion 1 in the +X direction (ST506).

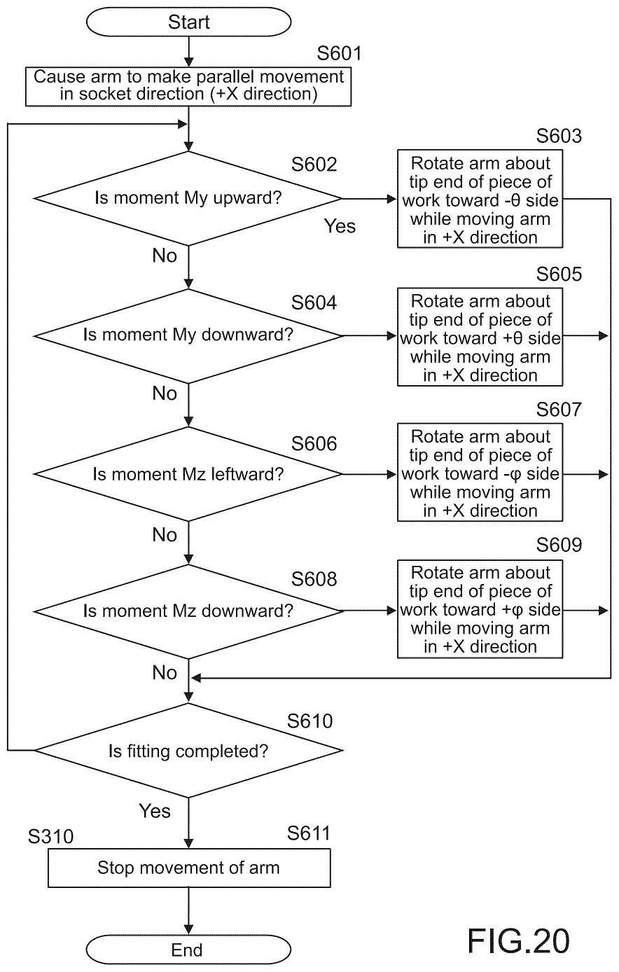

FIG. 20 is a flowchart showing an example of a processing procedure in which the fitting attitude control in the up-down direction and the fitting attitude control in the left-right direction, that have been described above, are integrated. Herein, descriptions will be given on a procedure in which the directions of the moments My and Mz acting on the piece of work W are determined individually, and the attitude of the piece of work W with respect to the socket hole 92 is corrected while adjusting the rotation direction of the arm portion 1 in accordance with the determination result.

The controller 11 generates a movement command used to cause the arm portion 1 to make a parallel movement in the +X direction from a fitting start position of the piece of work W with respect to the socket hole 92, to thus start fitting of the terminal portion Wb of the piece of work W into the socket hole 92 (ST601).

Next, the controller 11 determines whether the moment My acting on the piece of work W is upward (ST602). When determining that the moment My is upward, the controller 11 generates a control command used to rotate, around the tip end of the terminal portion Wb of the piece of work W, the arm portion 1 upwardly (−θ side) in the same direction as the moment My, while moving the arm portion 1 in the +X direction (ST603). On the other hand, when determining that the moment My acting on the piece of work W is downward, the controller 11 generates a control command used to rotate, around the tip end of the terminal portion Wb of the piece of work W, the arm portion 1 downwardly (+θ side) in the same direction as the moment My, while moving the arm portion 1 in the +X direction (ST604, 605).

On the other hand, when the moment acting on the piece of work W is the moment Mz about the Z axis, the controller 11 determines whether the moment Mz is leftward (ST606). When determining that the moment Mz is leftward, the controller 11 generates a control command used to rotate, around the tip end of the terminal portion Wb of the piece of work W, the arm portion 1 leftward (−φ side) in the same direction as the moment Mz, while moving the arm portion 1 in the +X direction (ST607). On the other hand, when determining that the moment Mz acting on the piece of work W is rightward, the controller 11 generates a control command used to rotate, around the tip end of the terminal portion Wb of the piece of work W, the arm portion 1 rightward (+φ side) in the same direction as the moment Mz, while moving the arm portion 1 in the +X direction (ST608, 609).

Next, the controller 11 determines whether the task of fitting the piece of work W into the socket hole 92 is completed (ST610). When the task of fitting the piece of work W into the socket hole 92 is completed (Yes in ST102), the controller 11 stops the parallel movement of the arm portion 1 in the +X direction (ST611). This allows the piece of work W to be properly fitted into the socket 90 while suppressing generation of prying of the piece of work W in the socket hole 92, so the piece of work W or the socket 90 can be prevented from being damaged due to the prying.

As described above, in the present embodiment, the magnitude and direction of the moment acting on the piece of work W are determined on the basis of the distributions of pressure detected by the sensor portions 20a and 20b provided on the gripping surface of the hand portion 3, and the position and attitude of the hand portion 3 with respect to the socket hole 92 are corrected on the basis of the determination result. This makes it possible to eliminate the influence of noise due to the vibration and inertia of the robot itself and ensure a highly accurate and an appropriate fitting task, as compared to a configuration in which a force sensor or the like is arranged at a wrist portion of a hand. In addition, since positioning of the piece of work W with respect to the socket hole 92 using a camera image becomes unnecessary, it is possible to suppress lowering of a work takt and suppress an increase of device costs and adjustment costs.

### Modified Examples

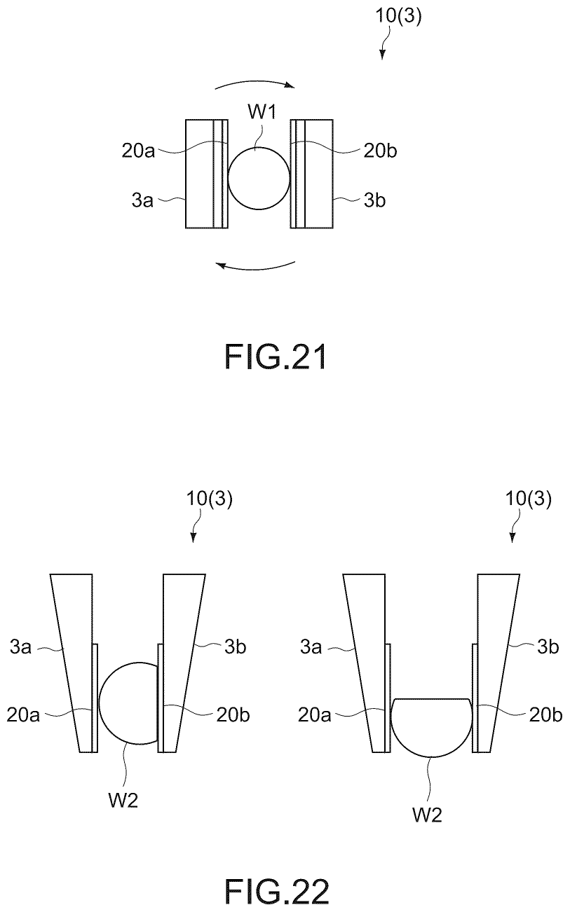

In the embodiment described above, the task of fitting the piece of work W into the socket hole 92 has been mainly described, but according to the robotic device 10 of the present embodiment, the piece of work to be gripped may be a bottle cap. In this case, as shown in FIG. 21, a rotational torque of a cap W2 can be detected on the basis of a shear force that acts on the sensor portions 20a and 20b at a time the cap W2 rotates along with an opening and closing operation of the bottle.

Further, as shown in FIG. 22, the robotic device 10 can detect a gripping attitude of a piece of work W2 having shape anisotropy. When the piece of work W2 has a partially-spherical shape that partially includes a flat surface portion, it can be determined, on the basis of the distributions of stress detected by the sensor portions 20a and 20b, whether the piece of work W2 is in, for example, a first attitude in which the flat surface portion is in the perpendicular direction as shown on the left side of the figure, or a second attitude in which the flat surface portion is in the horizontal direction as shown on the right side of the figure.

Further, in the embodiment described above, the capacitance-change-type detection element is used to detect the pressure distribution, but the present technology is not limited to this, and a resistance-change-type detection element whose resistance value changes according to the magnitude of the pressure, or the like may be used, for example.

Furthermore, in the embodiment described above, the directions of the moments My and Mz that are detected in the state where the terminal portion Wb of the piece of work W is pressing the opening surface 91 of the socket 90 in the X axis direction are determined (ST104, 204). However, when the moment is in an oblique direction that is tilted with respect to the Y axis direction and the Z axis direction, the terminal portion Wb may be positioned at the socket hole 92 by moving the arm portion 1 in the oblique direction.

It is noted that the present technology can also take the following configurations.

(1) A robotic device which fits a piece of work into a socket including an opening surface perpendicular to a direction of a first axis, the robotic device including:
a hand portion which includes a plurality of finger portions respectively including gripping surfaces with which the piece of work is graspable in a direction of a second axis, the second-axis direction being perpendicular to the first-axis direction;
a sensor portion which is provided to at least one of the plurality of finger portions, the sensor portion being capable of detecting a distribution of a pressure acting on the gripping surface; and
a control device configured to determine a direction of a moment that acts on the piece of work, on the basis of an output from the sensor portion that is obtained when the piece of work is pressed against the opening surface in the first-axis direction, and to generate, on the basis of the determined direction of the moment, a first control command used to correct a position of the hand portion such that the hand portion is at a position that enables the piece of work to be aligned with the socket in the first-axis direction.

(2) The robotic device according to (1), in which
the control device determines the direction of the moment about the second axis perpendicular to the gripping surface, and
on the basis of the determined direction of the moment, the control device generates, as the first control command, a control command used to cause the hand portion to make a parallel movement in a direction of a third axis that is parallel to the gripping surface and orthogonal to the first axis and the second axis.

(3) The robotic device according to (2), in which
the sensor portion is provided to each of the plurality of finger portions,
the control device determines the direction of the moment about the third axis, and
on the basis of the determined direction of the moment, the control device generates, as the first control command, a control command used to cause the hand portion to make a parallel movement in the second-axis direction.

(4) The robotic device according to any one of (1) to (3), in which
the control device
   further determines the direction of the moment acting on the piece of work, on the basis of the output from the sensor portion, the output being obtained when the piece of work is moved in the first-axis direction inside the socket, and
   generates a second control command used to correct an attitude of the hand portion, on the basis of the determined direction of the moment.

(5) The robotic device according to (4), in which
the direction of the moment about the second axis perpendicular to the gripping surface is determined, and
a control command used to rotate the hand portion around a tip end of the piece of work about the second axis in a same direction as the determined direction of the moment, is generated as the second control command.

(6) The robotic device according to (5), in which
the sensor portion is provided to each of the plurality of finger portions, and
the control device
   determines a direction about a third axis that is parallel to the gripping surface and orthogonal to the first axis and the second axis, and
   generates, as the second control command, a control command used to rotate the hand portion around the tip end of the piece of work about the third axis in the same direction as the determined direction of the moment.

(7) The robotic device according to any one of (1) to (6), in which
the sensor portion includes an elastically deformable sensor sheet including a plurality of capacitive elements detecting the pressure acting on the gripping surface.

(8) The robotic device according to (7), in which
the sensor sheet includes a pressure sensor including
   a sensor electrode layer including the plurality of capacitive elements arrayed in a matrix,
   a reference electrode layer connected to a reference potential, and
   a deformation layer arranged between the sensor electrode layer and the reference electrode layer.

(9) The robotic device according to (7), in which
the sensor sheet includes
   a pair of pressure sensors each including
      a sensor electrode layer including the plurality of capacitive elements arrayed in a matrix,
      a reference electrode layer connected to a reference potential, and
      a deformation layer arranged between the sensor electrode layer and the reference electrode layer, and
   a separation layer arranged between pressure sensors of the pair of pressure sensors, the separation layer being formed of a viscoelastic material.

(10) A method for controlling a robotic device which includes a hand portion including a plurality of finger portions respectively including gripping surfaces with which a piece of work is graspable in a second-axis direction perpendicular to a first-axis direction, and a sensor portion which is provided to at least one of the plurality of finger portions, the sensor portion being capable of detecting a distribution of a pressure acting on the gripping surface, the robotic device fitting the piece of work into a socket including an opening surface perpendicular to the first-axis direction, the method including:
determining a direction of a moment that acts on the piece of work, on the basis of an output from the sensor portion that is obtained when the piece of work is pressed against the opening surface in the first-axis direction; and
generating, on the basis of the determined direction of the moment, a control command used to move the hand portion to a position that enables the piece of work to be aligned with the socket in the first-axis direction.

### Reference Signs List

1 arm portion
3 hand portion
3a, 3b finger portion
10 robotic device
11 controller
12 drive portion
12a drive unit
20a, 20b sensor portion
23 separation layer
25 reference electrode layer
27 deformation layer
28 sensing portion
30 sensor electrode layer
70 control unit
90 socket
91 opening surface
92 socket hole
210, 220 sensor sheet
W work
Wa terminal portion

1. A robotic device which fits a piece of work into a socket including an opening surface perpendicular to a direction of a first axis, the robotic device comprising:
a hand portion which includes a plurality of finger portions respectively including gripping surfaces with which the piece of work is graspable in a direction of a second axis, the second-axis direction being perpendicular to the first-axis direction;
a sensor portion which is provided to at least one of the plurality of finger portions, the sensor portion being capable of detecting a distribution of a pressure acting on the gripping surface; and
a control device configured to determine a direction of a moment that acts on the piece of work, on a basis of an output from the sensor portion that is obtained when the piece of work is pressed against the opening surface in the first-axis direction, and to generate, on a basis of the determined direction of the moment, a first control command used to correct a position of the hand portion such that the hand portion is at a position that enables the piece of work to be aligned with the socket in the first-axis direction.

2. The robotic device according to claim 1, wherein
the control device determines the direction of the moment about the second axis perpendicular to the gripping surface, and
on the basis of the determined direction of the moment, the control device generates, as the first control command, a control command used to cause the hand portion to make a parallel movement in a direction of a third axis that is parallel to the gripping surface and orthogonal to the first axis and the second axis.

3. The robotic device according to claim 2, wherein
the sensor portion is provided to each of the plurality of finger portions,
the control device determines the direction of the moment about the third axis, and
on the basis of the determined direction of the moment, the control device generates, as the first control command, a control command used to cause the hand portion to make a parallel movement in the second-axis direction.

4. The robotic device according to claim 1, wherein
the control device
further determines the direction of the moment acting on the piece of work, on a basis of the output from the sensor portion, the output being obtained when the piece of work is moved in the first-axis direction inside the socket, and
generates a second control command used to correct an attitude of the hand portion, on the basis of the determined direction of the moment.

5. The robotic device according to claim 4, wherein
the direction of the moment about the second axis perpendicular to the gripping surface is determined, and
a control command used to rotate the hand portion around a tip end of the piece of work about the second axis in a same direction as the determined direction of the moment, is generated as the second control command.

6. The robotic device according to claim 5, wherein
the sensor portion is provided to each of the plurality of finger portions, and
the control device
determines a direction about a third axis that is parallel to the gripping surface and orthogonal to the first axis and the second axis, and
generates, as the second control command, a control command used to rotate the hand portion around the tip end of the piece of work about the third axis in the same direction as the determined direction of the moment.

7. The robotic device according to claim 1, wherein
the sensor portion includes an elastically deformable sensor sheet including a plurality of capacitive elements detecting the pressure acting on the gripping surface.

8. The robotic device according to claim 7, wherein
the sensor sheet includes a pressure sensor including
a sensor electrode layer including the plurality of capacitive elements arrayed in a matrix,
a reference electrode layer connected to a reference potential, and
a deformation layer arranged between the sensor electrode layer and the reference electrode layer.

9. The robotic device according to claim 7, wherein
the sensor sheet includes
a pair of pressure sensors each including
a sensor electrode layer including the plurality of capacitive elements arrayed in a matrix,
a reference electrode layer connected to a reference potential, and
a deformation layer arranged between the sensor electrode layer and the reference electrode layer, and
a separation layer arranged between pressure sensors of the pair of pressure sensors, the separation layer being formed of a viscoelastic material.

10. A method for controlling a robotic device which includes a hand portion including a plurality of finger portions respectively including gripping surfaces with which a piece of work is graspable in a second-axis direction perpendicular to a first-axis direction, and a sensor portion which is provided to at least one of the plurality of finger portions, the sensor portion being capable of detecting a distribution of a pressure acting on the gripping surface, the robotic device fitting the piece of work into a socket including an opening surface perpendicular to the first-axis direction, the method comprising:
determining a direction of a moment that acts on the piece of work, on a basis of an output from the sensor portion that is obtained when the piece of work is pressed against the opening surface in the first-axis direction; and
generating, on a basis of the determined direction of the moment, a control command used to move the hand portion to a position that enables the piece of work to be aligned with the socket in the first-axis direction.
